(19) United States
(12) Patent Application Publication
(10) Pub. No.: US 2014/0004288 A1
(43) Pub. Date: Jan. 2, 2014

(54) IMPACT-ABSORBING MATERIAL AND SEALING MATERIAL COMPRISING SAME

(71) Applicants: Keiji Wakayama, Saitama (JP); Kenji Miyazaki, Saitama (JP)

(72) Inventors: Keiji Wakayama, Saitama (JP); Kenji Miyazaki, Saitama (JP)

(21) Appl. No.: 13/993,381

(22) PCT Filed: Dec. 12, 2011
(86) PCT No.: PCT/JP2011/078730

§ 371 Date: Sep. 17, 2013

(30) Foreign Application Priority Data
Dec. 13, 2010 (JP) 2010-277258

(51) Int. Cl. C08L 53/02; C09J 7/02; C08L 31/04; C08L 23/12; C08L 23/06

(52) U.S. Cl. CPC C08L 53/02; C08L 23/12; C08L 23/06; C08L 31/04; C09J 7/0296
USPC 428/41.3; 521/85; 428/220; 428/521; 428/339; 428/354

(57) ABSTRACT

Provided is an impact absorbing material comprising a resin composition which contains (A) a block copolymer comprising polystyrene in its both end blocks and a conjugated diene polymer in its middle part block and (B) a thermoplastic resin, wherein the block copolymer (A) contains (A1) a block copolymer whose middle part block is not hydrogenated and (A2) a block copolymer whose middle part block is hydrogenated, wherein the maximum peak temperature of loss tangent (tan δ) of the block copolymer (A1) as obtained by a dynamic viscoelasticity measurement is in the range of −20° C. or higher and lower than 25° C., and the maximum peak temperature of loss tangent (tan δ) of the block copolymer (A2) as obtained by a dynamic viscoelasticity measurement is in the range of −30° C. or higher and lower than 25° C.

### TECHNICAL FIELD

The present invention relates to an impact absorbing material showing excellent bending strength and impact absorbing property under a low temperature environment and to a sealing material using the same.

### BACKGROUND ART

In a display device used in a personal computer, a mobile phone, an electronic paper, and so forth, a resin is arranged between a glass plate that constitutes the device surface and an image display member to absorb impact and vibration.

As to the resin used in the applications like these, for example, a damping and sound sealing composition comprising a block copolymer—formed of 1,2-polybutadiene, a vinyl aromatic compound, and a conjugated diolefin—and a rubber-like polymer having a tan δ peak at 100 Hz in a certain temperature range is reported in Patent Document 1.

Alternatively, in Patent Document 2, an expandable composition using a conjugated diene copolymer having its tan δ peak obtained by the dynamic viscoelasticity measurement thereof in a certain temperature range or using its hydrogenated homologue is reported.

Further, in Patent Document 3, a crosslinked, expanded body comprising a polyolefin resin and a copolymer having its tan δ peak obtained by the dynamic viscoelasticity measurement thereof in a certain temperature range is reported.
Patent Document 1: Japanese Patent Laid-Open Publication No. H2-209936
Patent Document 2: Japanese Patent Laid-Open Publication No. H5-345833
Patent Document 3: Japanese Patent Laid-Open Publication No. H8-277339

### SUMMARY OF THE INVENTION

### Problem to be Solved by the Invention

It is claimed that the resins and others reported in Patent Documents 1 to 3 have an impact absorbing capacity even under a low temperature environment. However, a problem was found that these resins are easily breakable if they are deformed under a low temperature environment so that they cannot express their impact absorbing capacities.

In view of the above-mentioned problem, the present invention has an object to provide; an impact absorbing material having excellent properties in both bending strength and impact absorption even under a low temperature environment; and a sealing material using this impact absorbing material.

### Means for Solving the Problem

Inventors of the present invention carried out an extensive investigation to solve the problem mentioned above, and as a result, it was found that the above-mentioned problem could be solved, in an impact absorbing material comprising a resin composition which contains (A) a block copolymer comprising polystyrene in its both end blocks and a conjugated diene polymer in its middle part block and (B) a thermoplastic resin, by using (A1) a specific block copolymer whose middle part block is not hydrogenated and (A2) a specific block copolymer whose middle part block is hydrogenated; and based on this finding, the present invention could be accomplished.

That is, the present invention provides the following (1) and (2).

(1) An impact absorbing material comprising a resin composition which contains (A) a block copolymer comprising polystyrene in its both end blocks and a conjugated diene polymer in its middle part block and (B) a thermoplastic resin, wherein

the block copolymer (A) contains (A1) a block copolymer whose middle part block is not hydrogenated and (A2) a block copolymer whose middle part block is hydrogenated, wherein

the maximum peak temperature of loss tangent (tan δ) of the block copolymer (A1) as obtained by a dynamic viscoelasticity measurement is in the range of −20° C. or higher and lower than 25° C., and

the maximum peak temperature of loss tangent (tan δ) of the block copolymer (A2) as obtained by a dynamic viscoelasticity measurement is in the range of −30° C. or higher and lower than 25° C.

(2) A sealing material formed by molding the impact absorbing material according to the above (1).

### Effect of the Invention

According to the present invention, provided are an impact absorbing material having excellent properties both in bending strength and impact absorption even under a low temperature environment of −20° C. or lower, and a sealing material using this impact absorbing material.

### BRIEF DESCRIPTION OF THE DRAWINGS

FIG. 1

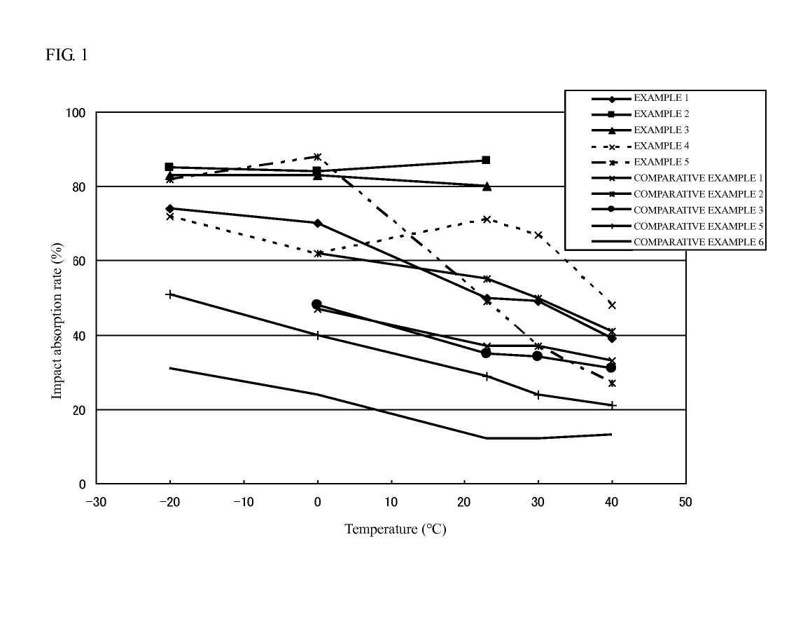

This is a graph showing a relationship between the impact absorption rate and temperature of the respective expanded sheets of the crosslinked resins of EXAMPLES and COMPARATIVE EXAMPLES.

### MODE FOR CARRYING OUT THE INVENTION

### 1. Impact Absorbing Material

The impact absorbing material of the present invention comprises a resin composition which contains (A) a block copolymer having polystyrene in its both end blocks and a conjugated diene polymer in its middle part block and (B) a thermoplastic resin.

### 1.1 Block Copolymer (A)

The block copolymer (A) comprising a diene polymer contains a block copolymer (A1) whose middle part block is not hydrogenated and a block copolymer (A2) whose middle part block is hydrogenated.

### 1.1.1. Block Copolymer (A1)

The block copolymer (A1) is the block copolymer whose middle part block is not hydrogenated with the maximum peak temperature of loss tangent (tan δ) thereof (hereinafter, this is sometimes referred to as “maximum peak temperature of tan δ) being in the range of −20° C. or higher and lower than 25° C. as obtained by a dynamic viscoelasticity measurement. In this block copolymer (A1), the maximum peak temperature of tan δ is preferably in the range of −10° C. or higher and lower than 25° C., and more preferably −5° C. or higher and lower than 25° C.

The maximum peak temperature of tan δ outside the above range is not desirable because the bending strength at −20° C. or lower is deteriorated.

Meanwhile, the term “maximum peak temperature of tan δ” in this specification means the value obtained by measurement with a dynamic viscoelasticity measurement instrument under the tensile mode with the temperature-raising rate of 3° C./minute and the frequency of 11 Hz. Illustrative example of the dynamic viscoelasticity measurement instrument usable for this measurement includes Rheovibron DDV-III (manufactured by Orientec Co., Ltd.).

The block copolymer (A1) used in the present invention can be produced by an anionic polymerization of styrene and any one of isoprene and butadiene or both by using an alkyl lithium compound as an initiator.

Illustrative example of the alkyl lithium compound includes an alkyl lithium having an alkyl group which has 1 to 10 carbon atoms such as methyl lithium, ethyl lithium, pentyl lithium, and butyl lithium; and a dilithium compound such as naphthalene dilithium and dithiohexylbenzene.

Illustrative example of the polymerization method includes: (I) a method in which, by using an alkyl lithium compound as an initiator, after styrene, isoprene and as appropriate butadiene or isoprene-butadiene are polymerized sequentially, and (II) a method in which after styrene, isoprene and then as appropriate butadiene or isoprene-butadiene are polymerized, and thereafter this is coupled by using a coupling agent. Illustrative example of the coupling agent includes dichloromethane, dibromomethane, and dibromobenzene.

To control the reaction properly, it is preferable to use a solvent during the polymerization. As to the solvent, an organic solvent that is inert to the polymerization initiator is used; and preferable example thereof includes an aliphatic, an alicyclic, and an aromatic hydrocarbon, each of them having 6 to 12 carbon atoms, such as hexane, heptane, cyclohexane, methylcyclohexane, and benzene.

The polymerization is done preferably at the temperature of 0 to 80° C. and with the time of 0.5 to 50 hours.

From a view point of the impact absorbing capacity, styrene content in the block copolymer (A1) is preferably in the range of 5 to 50% by mass, more preferably 10 to 30% by mass, and still more preferably 15 to 25% by mass. Rates of isoprene and butadiene in the block copolymer (A1) are controlled appropriately in the range of 0 to 100% for each.

Illustrative example of the block copolymer (A1) that is commercially available includes non-hydrogenated styrene-isoprene block copolymers Hybrar (registered trademark) 5127 (styrene content of 20% by mass and tan δ of 20° C., manufactured by Kuraray Co., Ltd.) and Hybrar (registered trademark) 5125 (styrene content of 20% by mass and tan δ of −3° C., manufactured by Kuraray Co., Ltd.).

The maximum peak temperatures of tan δ of the block copolymer (A1) and the later-mentioned block copolymer (A2) can be controlled by a method such as adjusting the number of the 3,4 bond or the 1,2 bond of isoprene and butadiene; and the control thereof can be done comparatively easily by using a Lewis base as a co-catalyst. Illustrative example of the Lewis base includes an ether such as dimethyl ether, diethyl ether, and tetrahydrofuran; a glycol ether such as ethylene glycol dimethyl ether and diethylene glycol dimethyl ether; and an amine compound such as triethylamine, N,N,N′,N′-tetramethyl ethylene diamine (TMEDA), and N-methyl morpholine. Amount of these Lewis bases is preferably in the range of 0.1 to 1,000 folds relative to the mol number of lithium in the polymerization initiator.

### 1.1.2. Block Copolymer (A2)

The block copolymer (A2) is the block copolymer whose middle part block is hydrogenated with the maximum peak temperature of tan δ thereof being in the range of −30° C. or higher and lower than 25° C. In this block copolymer (A2), the maximum peak temperature of tan δ is preferably in the range of −25° C. or higher and lower than 0° C., and more preferably −20° C. or higher and lower than 0° C.

The maximum peak temperature of tan δ outside the above range is not desirable because the bending strength at −20° C. or lower is deteriorated, similarly to the block copolymer (A1).

The block copolymer (A2) like this can be obtained by a heretofore known hydrogenation method of a block copolymer which is produced by the method for producing the block copolymer (A1). That is, this can be obtained by dissolving the said block copolymer in a solvent that is inert to the hydrogenation reaction and the hydrogenation catalyst followed by reacting it with hydrogen by using a heretofore known hydrogenation catalyst. Illustrative example of the catalyst includes: an inhomogeneous catalyst formed of a metal such as Raney nickel, Pt, Pd, Ru, Rh, and Ni, supported on a supporting material such as carbon, alumina, and diatom earth; and a Ziegler catalyst formed of a combination of a transition metal with an alkyl aluminum compound, an alkyl lithium compound, or the like. The hydrogen pressure is preferably in the range of normal pressure to 200 kg/cm²; the reaction temperature is preferably in the range of normal temperature to 250° C.; and the reaction time is preferably in the range of 0.1 to 100 hours. The polymer after the reaction can be obtained either by solidifying the reaction solution by using methanol and the like followed by heating or drying the resulting solid under reduced pressure, or by pouring the reaction solution into a boiling water, removing the solvent therein by azeotropic distillation, and thereafter heating or drying the resulting residue under reduced pressure.

In view of a higher bending strength, the hydrogenation rate of the middle part block of the block copolymer (A2) is preferably in the range of 50 to 95%, and more preferably 70 to 90%.

Meanwhile, in the present invention, the block copolymer (A2) may be a hydrogenated product of the block copolymer (A1) or a hydrogenated product of a block copolymer other than the block copolymer (A1).

From a view point of the impact absorption capacity, styrene content in the block copolymer (A2) is preferably in the range of 5 to 70% by mass, more preferably 5 to 50% by mass, or more preferably 10 to 50% by mass, or more preferably 10 to 30% by mass, and still more preferably 10 to 25% by mass. Rates of isoprene and butadiene in the block copolymer (A2) are controlled appropriately in the range of 0 to 100% for each.

Illustrative example of the block copolymer (A2) that is commercially available includes hydrogenated styrene-isoprene block copolymers Hybrar (registered trademark) 7125 (styrene content of 20% by mass and tan δ of −5° C., manufactured by Kuraray Co., Ltd.) and Hybrar (registered trademark) 7311 (styrene content of 12% by mass and tan δ of −17° C., manufactured by Kuraray Co., Ltd.), S. O. E. (registered trademark) S1611 (tan δ of 8° C., manufactured by Asahi Kasei Chemicals Co., Ltd.), S. O. E. (registered trademark) L609 (tan δ of 19° C., manufactured by Asahi Kasei Chemicals Co., Ltd.), S. O. E. (registered trademark) L611 (tan δ of 8° C., manufactured by Asahi Kasei Chemicals Co., Ltd.), and S. O. E. (registered trademark) L605 (tan δ of 17° C., manufactured by Asahi Kasei Chemicals Co., Ltd.).

The block copolymers (A1) and (A2) are not particularly restricted provided that they are conjugated diene copolymers satisfying the foregoing respective tan δ values, though a triblock copolymer of styrene and vinyl-polyisoprene is preferable, and a triblock copolymer comprising polystyrene in its both end blocks and vinyl-polyisoprene in its middle part block is more preferable.

In view of impact resistance, impact absorption, and workability, the number-average molecular weights of the block copolymers (A1) and (A2) are preferably in the range of 30,000 to 800,000, and more preferably 120,000 to 180,000. The glass transition temperature of the block copolymer (A1) is preferably in the range of −20 to 25° C., more preferably −15 to 20° C., and still more preferably −15 to 15° C. The glass transition temperature of the block copolymer (A2) is preferably in the range of −40 to 25° C., more preferably −40 to 0° C., or more preferably −40 to −10° C., and still more preferably −35 to −14° C.

It is preferable that the block copolymer (A) contain at least one each of a block copolymer having the grass transition temperature of 0° C. or higher and a block copolymer having the grass transition temperature of lower than 0° C. When at least one each of the block copolymers are contained therein, an excellent impact absorbing capacity may be obtained in a wide temperature range of the people's life.

Meanwhile, further addition of a block copolymer having the glass transition temperature outside the foregoing ranges to the block copolymer (A) may improve the impact absorbing capacity.

To increase the bending strength at the temperature of −20° C. or lower and to improve impact resistance and impact absorbing capacity at normal temperature, the blending amount of the block copolymer (A2) is preferably in the range of 20 to 85% by mass, more preferably 25 to 75% by mass, still more preferably 25 to 50% by mass, and further still more preferably 25 to 45% by mass, relative to totality of the block copolymer (A).

Meanwhile, in the present invention, a combination of two or more kinds of the block copolymers (A1) may be used; and a combination of two or more kinds of the block copolymers (A2) may be used as well.

It is preferable that the block copolymer (A1) and the block copolymer (A2) each contain at least one kind of the block copolymer with the maximum peak temperature of tan δ being 0° C. or higher and at least one kind of the block copolymer with the maximum peak temperature of tan δ being lower than 0° C. The block copolymer with the maximum peak temperature of tan δ being lower than 0° C. increases not only the bending strength of an impact absorbing material at low temperature but also the impact absorbing capacity thereof at the temperature of normal temperature or lower, while the block copolymer with the maximum peak temperature of tan δ being 0° C. or higher increases the impact absorbing capacity near normal temperature. If at least one each of the block copolymer with the maximum peak temperature of tan δ being lower than 0° C. and the block copolymer with the maximum peak temperature of tan δ being 0° C. or higher is contained therein, the impact absorbing capacity can be improved in a wide temperature range of the people's life.

Meanwhile, in the present invention, a block copolymer with the maximum peak temperature of tan δ being outside the above-mentioned range may be added further. Further addition of the block copolymer like this may improve the impact absorbing capacity in a wide temperature range of the people's life. As to the block copolymer with the maximum peak temperature of tan δ being outside the above-mentioned range, the difference from the upper limit or the lower limit in the temperature range of the maximum peak temperature of tan δ thereof is preferably 2° C. or more. The block copolymer like this may be used singly or as a mixture of two or more kinds thereof.

To widen the temperature range of expressing the impact absorbing capacity, the difference of the maximum peak temperature of tan δ between the block copolymers (A1) and (A2) is preferably 10° C. or more, or more preferably 15° C. or more, and preferably 35° C. or less. The relationship of this difference in the maximum peak temperature of tan δ may be satisfied by two resins that constitute the block copolymer (A1) or two resins that constitute the block copolymer (A2).

### 1.2. Thermoplastic Resin (B)

As to the thermoplastic resin, any of an amorphous thermoplastic resin and a crystalline thermoplastic resin may be used.

Illustrative example of the amorphous thermoplastic resin includes a polystyrene resin, a polymethacryl resin, and a polyvinyl chloride resin.

Illustrative example of the polystyrene resin includes polystyrene, a copolymer of styrene and a vinyl monomer that is copolymerizable with styrene, and a high impact polystyrene.

Illustrative example of the polymethacryl resin includes polymethyl acrylate, polymethyl methacrylate, and methyl methacrylate-styrene copolymer.

Illustrative example of the polyvinyl chloride resin includes polyvinyl chloride, vinyl chloride-ethylene copolymer, and vinyl chloride-vinyl acetate copolymer.

Illustrative example of other amorphous thermoplastic resins includes a cyclic olefin resin such as cycloolefin polymer Zeonor (registered trademark, manufactured by Zeon Corp.) and ethylene-tetracyclododecene copolymer Apel (registered trademark, manufactured by Mitsui Chemicals, Inc.), an aliphatic polyester, polyvinyl alcohol (PVA), and a biodegradable resin such as a cellulose derivative.

Illustrative example of the aliphatic polyester includes a polylactate (PLA) resin and its derivative and a compound obtained by polycondensation and the like between a glycol and an aliphatic dicarboxylic acid, such as polyethylene succinate, polybutylene succinate, polyhexamethylene succinate, polyethylene adipate, polyhexamethylene adipate, polybutylene adipate, polyethylene oxalate, polybutylene oxalate, polyneopentyl oxalate, polyethylene sebacate, polybutylene sebacate, and polyhexamethylene sebacate. Among them, a polylactate resin is preferable.

The polylactate resin is a polycondensation product of lactic acid or lactide. The polylactate resin has optical isomers of a D-body, a L-body, and a DL-body; and respective single bodies or a mixture of them may be included therein. The weight-average molecular weight (Mw) of the polylactate resin is preferably in the range of 100,000 to 400,000.

On the other hand, illustrative example of the crystalline thermoplastic resin includes a polyolefin resin, ethylene-vinyl acetate copolymer, a saturated polyester resin, and a thermoplastic polyimide resin.

Illustrative example of the polyolefin resin includes a polyethylene resin such as a high density polyethylene, a medium density polyethylene, a low density polyethylene, a linear low density polyethylene, an ethylene-α-olefin copolymer, ethylene-ethyl acrylate copolymer, and an ethylene-methacrylate copolymer; and a polypropylene resin such as polypropylene, propylene-ethylene random copolymer, and propylene-ethylene block copolymer.

Illustrative example of the saturated polyester resin includes polyethylene terephthalate and polybutylene terephthalate.

Of these thermoplastic resins, a polystyrene resin and a polylactate resin are preferable as the amorphous resins; and as the crystalline resins, a polyolefin resin such as a polyethylene resin and a polypropylene resin as well as ethylene-vinyl acetate copolymer are preferable. In particular, a polyethylene resin, a polypropylene resin, a polylactate resin, and ethylene-vinyl acetate copolymer are preferable.

The blending amount of the thermoplastic resin (B) relative to the block copolymer (A) is preferably in the range of 10 to 99% by mass, more preferably 10 to 60% by mass, or more preferably 15 to 55% by mass, still more preferably 18 to 50% by mass, and further still more preferably 20 to 45% by mass.

In the case that the resin composition of the present invention is made to an expanded body, the blending amount of the thermoplastic resin (B) relative to the block copolymer (A) is preferably in the range of 10 to 80% by mass, more preferably 15 to 55% by mass, or more preferably 18 to 50% by mass, and still more preferably 20 to 45% by mass. The above-mentioned blending amount of 80% or less by mass gives an expanded body having not only a good expanding property but also the impact absorbing capacity.

### 1.3. Other Components

The impact absorbing material of the present invention may contain a resin component other than the block copolymer (A) and the thermoplastic resin (B) within the range not adversely affecting the object of the present invention. The blending amount of the resin component other than the block copolymer (A) and the thermoplastic resin (B) is preferably 40 or less parts by mass, more preferably 35 or less parts by mass, and still more preferably 14 or less parts by mass, relative to 100 parts by mass of the totality of the block copolymer (A) and the thermoplastic resin (B).

In addition, in the present invention, additives such as a metal harm inhibitor, an antistatic agent, a stabilizer, a nucleating agent, a pigment, and an antioxidant with the type such as a phenol type, a phosphorous type, an amine type, and a sulfur type may be added as appropriate within the range not adversely affecting the object of the present invention. Adding amount of these additives is preferably in the range of 0.01 to 6 parts by mass relative to 100 parts by mass of the totality of the block copolymer (A) and the thermoplastic resin (B).

Furthermore, in the present invention, a compounding material such as a filler and a flame retardant with the types of a halogen type, a phosphorous type, and so forth may be used as appropriate within the range not adversely affecting the object of the present invention. It is preferable that these compounding materials be blended with the amount of 15 to 200 parts by mass relative to 100 parts by mass of the totality of the block copolymer (A) and the thermoplastic resin (B).

The above-mentioned other additives may be used singly or as a combination of two or more of them.

### 1.4. Characteristics of the Impact Absorbing Material

In view of improvement in the impact absorbing capacity and the water sealing property, the expansion rate of the resin composition to constitute the impact absorbing material of the present invention is preferably in the range of 1.0 to 25 cc/g, or preferably 1.0 to 20 cc/g, more preferably 1.1 to 20 cc/g, or more preferably 1.2 to 15 cc/g, still more preferably 1.5 to 10 cc/g, and further still more preferably 1.5 to 4.5 cc/g.

In view of the sealing property, the 30%-compressive strength of the resin composition to constitute the absorbing material is in the range of 15 to 300 kPa, more preferably 18 to 200 kPa, and still more preferably 20 to 100 kPa, as measured according to JIS K 6767. If the 30%-compressive strength is 15 kPa or more, the water sealing property and the air sealing property can be obtained. If the 30%-compressive strength is 300 kPa or lower, there is no fear of expansion of the space for sealing due to repulsion force of a sealing material.

Meanwhile, in the case that the air sealing property is especially required as the sealing material, the 25%-compressive hardness as measured according JIS K 6767 is preferably 10 kPa or more.

### 1.5. Method for Producing the Impact Absorbing Material

The impact absorbing material of the present invention may be produced by adding a heat-decomposable blowing agent to the resin composition which contains the block copolymer (A) and the thermoplastic resin (B), and then, after they are crosslinked to the crosslinking degree of 30 to 80%, blowing the resulting mixture by heating. Specifically, the production method having the following steps (1) to (3) is industrially advantageous.

Step (1): In this step, an expandable resin composition obtained by adding a heat-decomposable blowing agent to the resin composition which contains the block copolymer (A) and the thermoplastic resin (B) is charged into a kneading machine, and then they are melt-kneaded at the temperature lower than the decomposition temperature of the heat-decomposable blowing agent and molded to produce an expandable resin article having an intended shape.

Step (2): In this step, the expandable resin article obtained in Step (1) is exposed to an ionizing radiation beam whereby producing the expandable resin article which is crosslinked to the crosslinking degree of 30 to 80%.

Step (3): In this step, the expandable resin article crosslinked in Step (2) is expanded by heating at the temperature above the decomposition temperature of the heat-decomposable blowing agent to produce an expanded body of the crosslinked resin.

The impact absorbing material can be produced via these Steps.

Meanwhile, the following Step (4) may be arranged after Step (3).

Step (4): In this step, the expanded body of the crosslinked resin obtained in Step (3) is stretched to produce an expanded article having a controlled form of the air bubbles.

### 1.5.1. Step (1)

In Step (1), an expandable resin composition obtained by adding a heat-decomposable blowing agent to the resin composition which contains the block copolymer (A) and the thermoplastic resin (B) is charged into a kneading machine, and then they are melt-kneaded at the temperature lower than the decomposition temperature of the heat-decomposable blowing agent and molded to produce an expandable resin article having an intended shape.

Here, if necessary, in addition to the heat-decomposable blowing agent, a crosslinking adjuvant agent, an air bubble nucleating agent, and other additives may be added into the composition in advance. By adding the crosslinking adjuvant agent into the expandable resin composition, exposure dose of the ionizing radiation beam used in Step (2) can be reduced so that breakage of the bond and deterioration in the polyolefin resins caused by exposure to the ionizing radiation beam may be prevented from occurring.

Meanwhile, illustrative example of the kneading machine includes a generally used kneading machine such as a Banbury mixer, a roll, and an extruder such as a monoaxial extruder and a biaxial extruder, though an extruder is preferable.

### 1.5.1.1. Heat-Decomposable Blowing Agent

The heat-decomposable blowing agent having a decomposition temperature higher than a melting temperature of the resin composition can be used. For example, an organic or an inorganic chemical blowing agent having decomposition temperature of 160 to 270° C. may be used.

Illustrative example of the organic blowing agent includes an azo compound such as azodicarbonamide, a metal azodicarboxylate salt (such as barium azodicarboxylate), and azobisisobutyronitrile; a nitroso compound such as N,N′-dinitrosopentamethylene tetramine; a hydrazine derivative such as hydrazodicarbonamide, 4,4′-oxybis(benzenesulfonylhydrazide), and toluenesulfonyl hydrazide; and a semicarbazide compound such as toluene sulfonyl semicarbazide.

Illustrative example of the inorganic blowing agent includes an ammonium bicarbonate, sodium carbonate, ammonium hydrogen carbonate, sodium hydrogen carbonate, ammonium nitrite, sodium borohydride, and anhydrous monosodium citrate.

Among them, in view of forming fine air bubbles, and economy and safety aspects, an azo compound and a nitroso compound are preferable, while azodicarbonamide, azobisisobutyronitrile, and N,N′-dinitrosopentamethylene tetramine are more preferable, though azodicarbonamide is still more preferable.

These heat-decomposable blowing agents may be used singly or as a combination of two or more of them.

Adding amount of the heat-decomposable blowing agent is preferably in the range of 1.5 to 30 parts by mass, more preferably 2 to 30 parts by mass, and still more preferably 2 to 15 parts by mass, relative to 100 parts by mass of the totality of the block copolymer (A) and the thermoplastic resin (B), because the expandable resin article sometimes fails to expand if the adding amount thereof is too small, while air bubbles of the expanded resin body sometimes break if the adding amount thereof is too large.

To lower the decomposition temperature of the heat-decomposable blowing agent or to accelerate the decomposition rate, a decomposition-temperature controlling agent such as zinc oxide, zinc stearate, and urea may be contained therein. To control a heating equipment and surface condition of the expanded body, the decomposition-temperature controlling agent may be used with the amount thereof being, for example, in the range of 0.01 to 5 parts by mass relative to 100 parts by mass of the resin composition which contains the block copolymer (A) and the thermoplastic resin (B). As to this decomposition-temperature controlling agent that is commercially available, Adekastab (registered trademark) CDA-1 (manufactured by Adeka Corp.) may be mentioned.

### 1.5.1.2. Crosslinking Adjuvant Agent

As to the crosslinking adjuvant agent, a polyfunctional monomer may be used. Illustrative example thereof includes a compound having three functional groups in one molecule such as trimethylolpropane trimethacrylate, trimethylolpropane triacrylate, triallyl trimellitate ester, triallyl 1,2,4-benzenetricarboxylate ester, and triallyl isocyanurate; a compound having two functional groups in one molecule such as 1,6-hexanediol dimethacrylate, 1,9-nonanediol dimethacrylate, 1,10-decanediol dimethacrylate, and divinyl benzene; and diallyl phthalate, diallyl terephthalate, diallyl isophthalate, ethyl vinyl benzene, neopentylglycol dimethacrylate, lauryl methacrylate, and stearyl methacrylate.

These crosslinking adjuvant agents may be used singly or as a combination of two or more of them.

Adding amount of the crosslinking adjuvant agent is preferably in the range of 0.2 to 20 parts by mass, more preferably 0.3 to 15 parts by mass, or more preferably 0.4 to 10 parts by mass, and still more preferably 0.5 to 5 parts by mass, relative to 100 parts by mass of the totality of the block copolymer (A) and the thermoplastic resin (B). If the adding amount is 0.2 or more parts by mass, an intended crosslinking degree can be obtained stably during blowing of the expandable resin composition; and if the adding amount is 20 or less parts by mass, the crosslinking degree to be afforded to the expandable resin composition can be controlled.

### 1.5.2. Step (2)

In Step (2), the expandable resin article obtained in Step (1) is exposed to an ionizing radiation beam whereby producing the expandable resin article which is crosslinked to the crosslinking degree of 30 to 80%.

Illustrative example of the ionizing radiation beam includes an α-beam, a β-beam, a γ-beam, and an electron beam, while an electron beam is more preferable. If the exposure dose of the ionizing radiation beam to the expandable resin article is too small, there is a case that sufficient shear viscosity necessary to blow the expandable resin article cannot be obtained; on the other hand, if the exposure dose is too large, there is a case that shear viscosity of the expandable resin article becomes so high that the expandability thereof decreases thereby leading to difficulty in obtaining the expanded body of the crosslinked resin having a high expansion rate as well as to deteriorate in appearance of the expanded body of the crosslinked resin. Accordingly, the exposure dose of the ionizing radiation beam is preferably in the range of 1 to 10 Mrad, more preferably 2 to 8 Mrad, and still more preferably 3 to 6 Mrad.

If the crosslinking adjuvant agent is used, the exposure dose of the ionizing radiation beam is preferably in the range of 1 to 8 Mrad, more preferably 1.1 to 5 Mrad, and still more preferably 1.2 to 5 Mrad.

The exposure dose of the ionizing radiation beam is influenced by the ratio of the block copolymer (A) to the thermoplastic resin (B), the additives, and the like; and thus, the exposure dose is usually controlled with measuring the crosslinking degree.

Here, if the crosslinking degree of the expandable resin article is 30% or more, softening at high temperature becomes difficult so that heat resistance can be secured; while, if 80% or less, the molecular structure thereof is properly fixed by crosslinking so that the elongation property at high temperature can be improved thereby leading to improvement in moldability. The crosslinking degree is more preferably in the range of 35 to 78%, and still more preferably 45 to 75%.

The crosslinking degree may be measured by the following method. That is, the expandable resin article is cut to give a test piece having the thickness of about 1 mm and the mass of about 100 mg (A (mg) of the test piece mass), and this test piece is soaked in 30 cm³ of xylene and allowed to stand at 115 C.° for 24 hours; and then, insoluble matters are collected by filtration through a 200 mesh metal net and dried under vacuum, and thereafter, mass of the insoluble matters, B (mg), is accurately weighed. From the obtained value, the crosslinking degree can be calculated by the following equation.

Crosslinking Degree (% by mass)=(B/A)×100

The crosslinking degree can be appropriately controlled by the adding amount of the heat-decomposable blowing agent and the exposure dose of the ionizing radiation beam.

### 1.5.3. Step (3)

In Step (3), the expandable resin article crosslinked in Step (2) is expanded by heating at the temperature above the decomposition temperature of the heat-decomposable blowing agent to produce an expanded body of the crosslinked resin.

The expanding temperature by heating is usually in the range of 140 to 300° C., and preferably 150 to 260° C., though depending on the decomposition temperature of the heat-decomposable blowing agent.

The impact absorbing material comprising the expanded body of the crosslinked resin produced by the method as shown above has an alloy structure formed of the block copolymer (A) and the thermoplastic resin (B). Because it has not only excellent heat resistance, shaping properties, and moldability, but also an excellent balance of physical properties such as flexibility and elongation, it can be processed to a fine and uniform expanded article having an excellent appearance by a heretofore known molding method such as a stamping molding method and a vacuum molding method.

### 1.5.4. Step (4)

In the above-mentioned production method, after Step (3), to control the form of the air bubbles, Step (4) in which the expanded body of the crosslinked resin is stretched may be arranged.

The air bubbles of the expanded body of the crosslinked resin is preferably in the form having the ratio of MD/TD preferably in the range of 4/1 to 2/1 and the ratio of (average of MD and TD)/ZD preferably in the range of 2/1 to 20/1, provided that the air bubble's diameter in the lamination direction (thickness direction of the expanded body of the crosslinked resin) on the occasion of laminating the expanded body of the crosslinked resin as the impact absorbing material to a body to be adhered is taken as ZD, the air bubble's diameter in the stretching direction of the expanded body of the crosslinked resin is taken as MD, and the air bubble's diameter in the perpendicular direction to the stretching direction is taken as TD.

To reduce distortion during stretching, this stretching may be done with heating; alternatively the heating may be done after stretching. The heating temperature in the case that the stretching is done with heating is preferably in the range of 100 to 250° C. The heating temperature, in the case that the heating is done after stretching, is preferably in the range of 50 to 150° C., and the heating time is preferably in the range of about one hour to about one week.

The impact absorbing material comprising the expanded body of the crosslinked resin produced by the method as mentioned above has, even if the compression rate is 50% or less, excellent air sealing property and dust resistance as well as a low repulsive power during compression.

In addition, the expanded body of the crosslinked resin obtained via the afore-mentioned Step (4), too, has not only excellent heat resistance, shaping properties, and moldability, but also an excellent balance of physical properties such as flexibility and elongation; and thus, it can be processed to a fine and uniform expanded article having an excellent appearance by a heretofore known molding method such as a stamping molding method and a vacuum molding method.

### 2. Sealing Material

The sealing material of the present invention comprises the above-mentioned impact absorbing material. In view of the sealing capacity, thickness of the sealing material of the present invention is 0.05 mm or more, preferably in the range of 0.05 to 2.0 mm, more preferably 0.1 to 2 mm, or more preferably 0.1 to 1 mm.

In the present invention, a thermoplastic resin film may be laminated on one side of the sealing material. Illustrative example of the thermoplastic resin for the laminating film includes a polyolefin resin such as a very low density to a high density polyethylene and polypropylene, and a polyester resin such as polyethylene terephthalate resin. Thickness of the thermoplastic resin film is preferably in the range of 10 to 300 μm and more preferably 10 to 200 μm in view of the water sealing property.

In the present invention, a pressure-sensitive adhesive layer may be formed on the side other than the side to which the thermoplastic resin film is laminated; and in addition, a releasing paper may be arranged such that this pressure-sensitive adhesive layer may be covered.

Illustrative example of the material for this releasing paper includes a polyolefin resin such as a very low density to a high density polyethylene and polypropylene, and a polyester resin such as polyethylene terephthalate resin.

Thickness of this releasing paper is preferably in the range of 10 to 300 μm and more preferably 10 to 200 μm. When the impact absorbing material of the present invention is in the form of a sheet, adhesion of the sheets among themselves may be prevented from occurring by laminating the releasing paper. In addition, stretch can be suppressed on the occasion of processing thereof. To suppress this stretch, thickness of the releasing paper is preferably in the range of 10 to 300 μm and more preferably 10 to 200 μm.

### EXAMPLES

### Examples 1 to 5 and Comparative Examples 1 to 6

Raw materials used in each of EXAMPLES and COMPARATIVE EXAMPLES are as following. Meanwhile, the maximum peak temperature of tan δ and the glass transition temperature of each of the used block copolymers (A1-1) to (A2-2) are shown in Table 1.

### Block Copolymer (A1):

(A1-1): Hybrar (registered trademark) No. 5127 (manufactured by Kuraray Co., Ltd.)

(A1-2): Hybrar (registered trademark) No. 5125 (manufactured by Kuraray Co., Ltd.) Block copolymer (A2):

(A2-1): Hybrar (registered trademark) No. 7125 (manufactured by Kuraray Co., Ltd.)

(A2-2): Hybrar (registered trademark) No. 7311 (manufactured by Kuraray Co., Ltd.)

Meanwhile, all of the block copolymers (A1-1) to (A2-2) used in the present EXAMPLES are constituted of a vinyl-polyisoprene polymer in its middle part block.

TABLE 1

| | | Maximum peak | Glass transition |
|---|---|---|---|
| Block copolymer | Styrene content | temperature of tanδ | temperature |
| (A) | (% by mass) | (° C.) | (° C.) |
| A1-1 | 20 | 20 | 8 |
| A1-2 | 20 | −3 | −13 |
| A2-1 | 20 | −5 | −15 |
| A2-2 | 12 | −17 | −32 |

### Thermoplastic Resins (B):

(B-1): EG 8B (random polypropylene, manufactured by Japan Polypropylene Corp.)

(B-2): EXACT 3027 (polyethylene, manufactured by Exxon Mobil Chemical Company)

(B-3): EVA 460 (ethylene-vinyl acetate copolymer, manufactured by Du Pont-Mitsui Polychemicals, Co., Ltd.)

### Heat-Decomposable Blowing Agent:

AC #K3 (azodicarbonamide, manufactured by Eiwa Chemical Ind. Co., Ltd.) Decomposition-temperature controlling agent:

Adekastab (registered trademark) No. CDA-1 (manufactured by Adeka Corp.) Phosphorous type antioxidant:

Adekastab (registered trademark) No. FP-2000 (manufactured by Adeka Corp.)

The respective above-mentioned raw materials were blended according to Table 2, and the resulting mixture was melt kneaded in an extruder at 170° C. to obtain a resin sheet having thickness of 0.8 mm and width of 300 mm.

The resin sheet thus obtained was exposed to an electron beam on its both sides with acceleration voltage of 800 kV and the exposure dose of 3.6 Mrad for crosslinking; and then, this crosslinked resin sheet was passed through an oven heated at 250° C. for expansion to obtain an expanded sheet of the crosslinked resin.

Then, this expanded sheet of the crosslinked resin was fed to an oven heated at 200° C., and the expanded sheet of the crosslinked resin was stretched, while being expanding, to the direction of sheet extrusion; during this process, the ratio between the feeding rate and the rolling-up rate of the expanded sheet of the crosslinked resin coming out from the oven (rolling-up rate of the expanded sheet of the crosslinked resin/feeding rate of the expanded sheet of the crosslinked resin to the oven) was kept 3.7.

As to the expanded sheet of the crosslinked resin thus obtained, thickness after heating, expansion rate, bending strength at −20° C., and each impact absorption rate at respective temperatures were measured. The measurement methods for respective properties are as following.

### Measurement Method of the Expansion Rate:

This ratio was obtained by dividing the density of the material before expansion p (g/cm³) with the density of the expanded sheet of the crosslinked resin ρ_{f} (g/cm³).

### Measurement Method of the Impact Absorption Rate:

The expanded sheet of the crosslinked resin, the absorption rate of which being to be measured, was placed in the center of an acryl plate (square 100 mm on a side, thickness of 10 mm); and an acceleration speed measurement sensor was attached to the acryl plate on the side not arranged with the expanded sheet of the crosslinked resin. An iron ball having the weight of 15 g was dropped from the height of 200 mm onto surface of the expanded sheet of the crosslinked resin placed on this acryl plate, and the acceleration speed at the moment of collision to the expanded sheet of the crosslinked resin was measured; and then the impact absorption rate was calculated by substituting the measured acceleration speed into the following equation.

X: Acceleration speed when the iron ball was dropped without attaching the expanded sheet of the crosslinked resin.
Y: Acceleration speed when the iron ball was dropped with attaching the expanded sheet of the crosslinked resin.

Impact Absorption Rate (%)=(X−Y)/X×100

### Impact Absorbing Capacity at Low Temperature:

The impact absorbing capacity at low temperature was evaluated from the results of the impact absorption rate measurement as mentioned above.

(A) The impact absorption rate at −20° C. is 80% or more and the impact absorption rate at 23° C. is 45% or more.
(B) The impact absorption rate at −20° C. is 60% or more and the impact absorption rate at 23° C. is 45% or more.
(C) Conditions of (A) and (B) are not fulfilled.

### Measurement Method of the Bending Strength at −20° C.:

A test piece of the expanded body of the crosslinked resin having thickness of 0.4 mm, width of 30 mm, and length of 100 mm was placed between two working benches such that the distance between the supporting points of both ends of the test piece might become 30 mm. The central part of this test piece was pressed with the testing rate of 10 mm/minute at −20° C. to measure the bending strength. The test piece not broken even after one minute or longer after start of the test was evaluated as “passed” (P), while the test piece broken within one minute after start of the test was evaluated as “failed” (F).

### Release Characteristics:

The expanded body obtained in EXAMPLES 1 to 5 each was cut into the size of 30 cm×30 cm to prepare 10 pieces each. As the releasing papers, nine polyester resin films (30 cm×30 cm) having thickness of 50 μm were interposed between the expanded bodies, and then they were piled up. In addition, an iron plate (30 cm×30 cm×5 mm) was put on it; and then, they were allowed to stand for 24 hours.

After the iron plate was removed, the releasing state between the expanded body and the releasing paper was evaluated by the eye observation; and then, it was found that all of the expanded bodies in EXAMPLES 1 to 5 were released, showing that these have excellent releasing characteristics.

TABLE 2

| | | | | EXAMPLE | | | | | COMPARATIVE EXAMPLE | | | | | |
|---|---|---|---|---|---|---|---|---|---|---|---|---|---|---|
| | | | | 1 | 2 | 3 | 4 | 5 | 1 | 2 | 3 | 4 | 5 | 6 |
| Composition | (A) | (A-1) | A1-1 | 30 | 40 | 20 | 60 | — | 50 | 50 | 50 | 30 | — | — |
| (parts by | | | A1-2 | 30 | — | — | — | 60 | 20 | 20 | 20 | 40 | — | — |
| mass) | | (A-2) | A2-1 | — | 20 | 20 | — | — | — | — | — | — | — | — |
| | | | A2-2 | 20 | 10 | 30 | 20 | 20 | — | — | — | — | — | — |

| | | | | | | | | | | | | |
|---|---|---|---|---|---|---|---|---|---|---|---|---|
| (B) | B-1 | 20 | 20 | 20 | 20 | 20 | 20 | 20 | 20 | 20 | — | — |
| | B-2 | — | — | — | — | — | — | — | — | — | 100 | 100 |
| | B-3 | — | 10 | 10 | — | — | 10 | 10 | 10 | 10 | — | — |
| Other | Heat-decomposable blowing agent | 2.5 | 2.5 | 2.5 | 3 | 3 | 2.5 | 2.5 | 3 | 3 | 2.5 | 4.5 |
| components | Decomposition-temperature | 1 | 1 | 1 | 1 | 1 | 1 | 1 | 1 | 1 | 1 | 1 |
| | controlling agent | | | | | | | | | | | |
| | Antioxidant | 0.5 | 0.5 | 0.5 | 0.5 | 0.5 | 0.5 | 0.5 | 0.5 | 0.5 | 0.5 | 0.5 |

| Blending ratio | Totality of (A) (parts by mass) | | 80 | 70 | 70 | 80 | 80 | 70 | 70 | 70 | 70 | 0 | 0 |
|---|---|---|---|---|---|---|---|---|---|---|---|---|---|
| | Totality of (B) (parts by mass) | | 20 | 30 | 30 | 20 | 20 | 30 | 30 | 30 | 30 | 100 | 100 |
| | (A2)/(A) (% by mass) | | 25.0 | 42.9 | 71.4 | 25.0 | 25.0 | 0 | 0 | 0 | 0 | — | — |
| | (B)/(A) (% by mass) | | 25.0 | 42.9 | 42.9 | 25.0 | 25.0 | 42.9 | 42.9 | 42.9 | 42.9 | — | — |
| Physical | Thickness (mm) | | 0.50 | 0.86 | 0.65 | 0.47 | 0.44 | 0.40 | 0.50 | 0.50 | 0.50 | 0.50 | 0.50 |
| properties | Expansion rate (cc/g) | | 3.0 | 3.0 | 2.5 | 4.1 | 3.9 | 3.0 | 3.0 | 5.0 | 5.0 | 3.0 | 5.0 |
| | Impact absorption rate (%) | −20° C. | 74 | 85 | 83 | 72 | 82 | — | — | — | — | 51 | 31 |
| | | −10° C. | 70 | 84 | 81 | 66 | 87 | — | — | — | — | — | — |
| | | 0° C. | 70 | 84 | 83 | 62 | 88 | 47 | 62 | 48 | — | 40 | 24 |
| | | 10° C. | 67 | 87 | 80 | 59 | 81 | — | — | — | — | — | — |
| | | 23° C. | 50 | 87 | 80 | 71 | 49 | 53 | 37 | 35 | — | 29 | 11 |
| | | 30° C. | 49 | — | — | 67 | 37 | 37 | 50 | 34 | — | 24 | 12 |
| | | 40° C. | 39 | — | — | 48 | 27 | 33 | 41 | 31 | — | 21 | 13 |

| | | | | | | | | | | | |
|---|---|---|---|---|---|---|---|---|---|---|---|
| Impact absorbing capacity at low temperature | B | A | A | B | A | C | C | C | C | C | C |
| Bending strength at −20° C. | P | P | P | P | P | F | F | F | F | P | P |

From Table 2, it can be seen that the impact absorbing materials blended with the block copolymers (A-1) and (A-2) therein and having specific maximum peak temperatures of tan δ have excellent impact absorbing capacity and bending strength at −20° C.

### INDUSTRIAL APPLICABILITY

The impact absorbing material of the present invention shows an excellent impact absorbing capacity and a high bending strength even under a low temperature environment of −20° C. or lower. In addition, the sealing material of the present invention can be suitably used as a sealing material of a personal computer, a mobile phone, an electronic paper, and so forth. Further, this sealing material can be suitably used as a sealing material that can suppress breakage of a liquid crystal display due to impact to an electronic appliance provided with an image display device.

1. An impact absorbing material comprising a resin composition which contains (A) a block copolymer comprising polystyrene in its both end blocks and a conjugated diene polymer in its middle part block and (B) a thermoplastic resin, wherein
the block copolymer (A) contains (A1) a block copolymer whose middle part block is not hydrogenated and (A2) a block copolymer whose middle part block is hydrogenated, wherein
the maximum peak temperature of loss tangent (tan δ) of the block copolymer (A1) as obtained by a dynamic viscoelasticity measurement is in the range of −20° C. or higher and lower than 25° C., and
the maximum peak temperature of loss tangent (tan δ) of the block copolymer (A2) as obtained by a dynamic viscoelasticity measurement is in the range of −30° C. or higher and lower than 25° C.

2. The impact absorbing material according to claim 1, wherein the rate of the block copolymer (A2) contained in the block copolymer (A) is in the range of 20 to 85% by mass.

3. The impact absorbing material according to claim 1, wherein the thermoplastic resin (B) is blended in the range of 10 to 99% by mass relative to the block copolymer (A).

4. The impact absorbing material according to claim 1, wherein the block copolymer (A) is a triblock copolymer comprising polystyrene in its both end blocks and vinyl-polyisoprene in its middle part block.

5. The impact absorbing material according to claim 1, wherein the thermoplastic resin (B) is at least one kind selected from a polyethylene resin, a polypropylene resin, a polylactate resin, and ethylene-vinyl acetate copolymer.

6. The impact absorbing material according to claim 1, wherein the resin composition is an expanded body with the expansion rate thereof being in the range of 1.0 to 25 cc/g and the 30%-compressive strength thereof being in the range of 15 to 300 kPa as measured according to JIS K 6767.

7. The impact absorbing material according to claim 1, wherein any one of the block copolymer (A1) and the block copolymer (A2) or both are a mixture of two or more kinds of any one of the block copolymer (A1) and the block copolymer (A2) or both, wherein the difference of the maximum peak temperatures of loss tangent (tan δ) as obtained by a dynamic viscoelasticity measurement between the said two or more block copolymers is in the range of 10 to 35° C.

8. The impact absorbing material according to claim 1, wherein the glass transition temperature of the block copolymer (A1) is in the range of −20 to 25° C. and the glass transition temperature of the block copolymer (A2) is in the range of −40 to 25° C.

9. The impact absorbing material according to claim 8, wherein the glass transition temperature of the block copolymer (A1) is in the range of −15 to 15° C. and the glass transition temperature of the block copolymer (A2) is in the range of −40 to 0° C.

10. A sealing material formed by molding the impact absorbing material according to claim 1.

11. The sealing material according to claim 10, wherein thickness thereof is in the range of 0.1 to 2.0 mm.

12. The sealing material according to claim 10, wherein a pressure-sensitive adhesive layer is arranged on at least one side of the sealing material.

13. The sealing material according to claim 10, wherein a thermoplastic resin film is laminated on at least one surface of the sealing material.

14. The sealing material according to claim 13, wherein the thermoplastic resin film is a polyester resin film whose thickness is in the range of 10 to 300 μm.

15. The sealing material according to claim 13, wherein a pressure-sensitive adhesive layer is arranged on the other side of the sealing material than the side to which the thermoplastic resin film is laminated.

16. The sealing material according to claim 15, wherein a releasing paper is arranged on surface of the pressure-sensitive adhesive layer.
